(19) United States
(12) Patent Application Publication
(10) Pub. No.: US 2025/0035757 A1
(43) Pub. Date: Jan. 30, 2025

(54) OPTICAL RANGING DEVICE

(71) Applicant: DENSO CORPORATION, Kariya-city (JP)

(72) Inventor: Kosuke NIIMURA, Kariya-city (JP)

(21) Appl. No.: 18/910,522

(22) Filed: Oct. 9, 2024

Related U.S. Application Data
(63) Continuation of application No. PCT/JP2023/014131, filed on Apr. 5, 2023.

(30) Foreign Application Priority Data
Apr. 13, 2022 (JP) 2022-066519
Nov. 9, 2022 (JP) 2022-179811

(51) Int. Cl. G01S 7/4865; G01S 7/481; G01S 17/894

(52) U.S. Cl. CPC G01S 7/4865; G01S 7/4815; G01S 7/4816; G01S 17/894

(57) ABSTRACT

An optical ranging device detects a distance to a target by using a round-trip time of light. The optical ranging device includes a light receiving module that is a plate-shaped member on which detectors are arranged and responds to sensing light having a predetermined wavelength, light emitting elements configured to emit the sensing light, and an aperture module disposed upward of the light receiving module. The aperture module is a plate-shaped member having openings through which reflected light passes toward the detectors. The reflected light is the sensing light reflected by the target. The light emitting elements are provided on portions of the aperture module where the openings are not provided on the aperture module.

### CROSS REFERENCE TO RELATED APPLICATIONS

The present application is a continuation application of International Patent Application No. PCT/JP2023/014131 filed on Apr. 5, 2023, which designated the U.S. and claims the benefit of priority from Japanese Patent Application No. 2022-066519 filed on Apr. 13, 2022, and Japanese Patent Application No. 2022-179811 filed on Nov. 9, 2022. The disclosures of all the above applications are incorporated herein.

### TECHNICAL FIELD

The present disclosure relates to an optical ranging device that detects a distance to an object.

### BACKGROUND

An optical ranging device includes a light receiving module that is disposed to face an irradiation unit including light emitting elements arranged in a matrix to emit sensing light. The light receiving module includes detectors arranged in a matrix and configured to respond to the sensing light reflected by an object. The optical ranging device detects a position of an object by using a time it takes for emitted sensing light to be reflected by the object and returned.

### SUMMARY

According to at least one embodiment of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The reflected light is the sensing light reflected by the target. The light emitting elements are provided on portions of the aperture module where the openings are not provided on the aperture module.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a block diagram illustrating a configuration of an optical ranging device.

FIG. 2 is a diagram illustrating a configuration of a light receiving module.

FIG. 3 is a diagram illustrating a configuration of a detector.

FIG. 4 is a diagram illustrating a configuration of an irradiation unit.

FIG. 5 is a diagram illustrating an example of a procedure for manufacturing an irradiation array unit.

FIG. 6 is a diagram illustrating another example of a procedure for manufacturing the irradiation array unit.

FIG. 7 is a diagram for illustrating the light emitting element and an aperture with dimensions.

FIG. 8 is a diagram illustrating a package including a light receiving substrate and an irradiation substrate.

FIG. 9 is a diagram illustrating an example of a configuration of an optical unit.

FIG. 10 is a diagram illustrating a path of irradiation light.

FIG. 11 is a diagram illustrating a field of view of the detectors.

FIG. 12 is a functional block diagram of a control unit.

FIG. 13 is a diagram illustrating a comparative configuration.

FIG. 14 is a diagram illustrating a configuration in which auxiliary lenses are provided below the apertures.

FIG. 15 is a diagram illustrating another example of the configuration in which the auxiliary lenses are provided below the apertures.

FIG. 16 is a diagram illustrating an example of a configuration in which diffusion plates are provided below of the apertures.

FIG. 17 is a diagram illustrating a configuration in which a heat conductor is disposed around the light emitting elements.

FIG. 18 is a view illustrating an example of introduction of an upper heat conductor.

FIG. 19 is a diagram illustrating a configuration in which heat conductors are disposed below the light emitting elements.

FIG. 20 is a diagram illustrating a configuration in which a microlens array is disposed above the irradiation array unit.

FIG. 21 is a diagram illustrating a configuration in which a VCSEL array and an aperture array are separated.

FIG. 22 is a diagram illustrating a configuration in which an optical path distribution unit is provided above the irradiation array unit.

FIG. 23 is a diagram illustrating another example of the configuration of the optical ranging device.

FIG. 24 is a diagram illustrating an example of setting sizes of pixel groups according to pixel positions.

FIG. 25 is a diagram illustrating a modification of the detector.

FIG. 26 is a diagram illustrating a configuration in which a condenser lens is disposed between the irradiation array unit and a light-receiving array unit.

FIG. 27 is a diagram illustrating another example of the configuration in which a condenser lens is disposed between the irradiation array unit and a light-receiving array unit.

FIG. 28 is a diagram illustrating a configuration of a microlens array functioning as a condenser lens.

### DETAILED DESCRIPTION

An optical ranging device according to a comparative example has a configuration in which a light receiving module is disposed to face an irradiation unit including light emitting elements arranged in a matrix and configured to emit sensing light. The light receiving module includes detectors arranged in a matrix and configured to respond to the sensing light reflected by an object. Here, the optical ranging device detects a position of an object by using a time it takes for emitted sensing light to be reflected by the object and returned. An optical configuration according to another comparative example outputs laser light diffused in a desired angular range.

In the comparative examples, in order to secure an optical path of light emitted from the light emitting elements, it is necessary to arrange the detectors at certain intervals, which may reduce spatial resolution.

In contrast, the present disclosure provides an optical ranging device capable of improving object detection performance.

According to a first aspect of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having point-shaped openings through which reflected light passes toward the detectors. The reflected light is the sensing light reflected by the target. The light emitting elements are provided on portions of the aperture module where the openings are not provided on the aperture module.

According to the first aspect, the light emitting elements are arranged upward of the light receiving module. According to the configuration, it is not necessary to provide gaps between the detectors for the sensing light emitted by the light emitting elements to pass through. That is, according to the above configuration, the detectors can be densely arranged. As a result, object detection performance (for example, spatial resolution) can be improved.

According to a second aspect of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The reflected light is the sensing light reflected by the target. The light emitting elements are provided on portions of the aperture module where the openings are not provided on the aperture module. A heat conductor is arranged on a portion of the aperture module behind the light emitting elements.

According to the second aspect, the object detection performance can be improved with effects similar to the effects of the first aspect. In addition, in the second aspect described above, because the heat conductor is provided behind the light emitting elements, heat dissipation can be improved.

According to a third aspect of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The reflected light is the sensing light reflected by the target. The light emitting elements are provided on portions of the aperture module where the openings are not provided on the aperture module. The opening are circular.

With the third aspect also, the object detection performance can be improved with effects similar to the effects of the first aspect.

According to a fourth aspect of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The reflected light is the sensing light reflected by the target. The light emitting elements are provided on portions of the aperture module where the openings are not provided on the aperture module. The openings are arranged in a staggered manner.

According to the fourth aspect, the amount of reflected light incident on each of the openings can be increased as compared with a configuration in which the openings are arranged in a lattice pattern, and the object detection performance can be further improved.

According to a fifth aspect of the present disclosure, an optical ranging device detects a distance to a target by using a round-trip time of light. The optical ranging device includes a light receiving module, light emitting elements and an aperture module. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The reflected light is the sensing light reflected by the target. The light emitting elements are provided on portions of the aperture module where the openings are not provided on the aperture module. The aperture module is a module in which the openings are through-holes formed on a metal plate.

According to the fifth aspect, with the above effects, the object detection performance can be improved, and the aperture module itself plays a role of releasing heat of the light emitting elements. Therefore, it is possible to reduce chances of the light emitting elements being inactivated or malfunctioning due to heat.

According to a sixth aspect of the present disclosure, an optical ranging device detects a distance to a target by using a round-trip time of light. The optical ranging device includes a light receiving module, light emitting elements, an aperture module, and an image generating part. The light receiving module is a plate-shaped member on which detectors are arranged, and the detectors are configured to respond to sensing light having a predetermined wavelength. The light emitting elements are configured to emit the sensing light. The aperture module is disposed upward of the light receiving module and is a plate-shaped member having openings through which reflected light passes toward the detectors. The image generation part is configured to generate a range image based on output signals from the detectors, and each pixel of the range image indicates a distance to the target in a predetermined direction. The reflected light is the sensing light reflected by the target. The light emitting elements are provided on portions of the aperture module where the openings are not provided on the aperture module. Each of the detectors includes light receiving elements, and number of the light receiving elements included in each of the detectors is different between a central portion and a peripheral portion of the light receiving module.

According to the sixth aspect, it is possible to improve the object detection performance, and to reduce chances of a decrease in distance measurement sensitivity of a pixel positioned in the peripheral portion of the range image as compared with a pixel positioned in the central portion of the range image.

According to a seventh aspect of the present disclosure, an optical ranging device detects a distance to a target by using a round-trip time of light. The optical ranging device includes an irradiation module, a light receiving module, and an aperture array. The irradiation module includes a plate-shaped member and light emitting elements provided on the plate-shaped member. The light emitting elements are configured to emit sensing light having a predetermined wavelength. The plate-shaped member transmits the sensing light. The light receiving module is a plate-shaped member on which detectors are arranged, and the detectors are configured to respond to the sensing light. The aperture array is a plate-shaped member including openings through which reflected light passes toward the detectors, and the reflected light is the sensing light reflected by the target. The irradiation module is disposed upward of the light receiving module and faces the light receiving module. The aperture array is disposed between the light receiving module and the irradiation module.

The seventh aspect described above can also improve the object detection performance similarly to the first aspect.

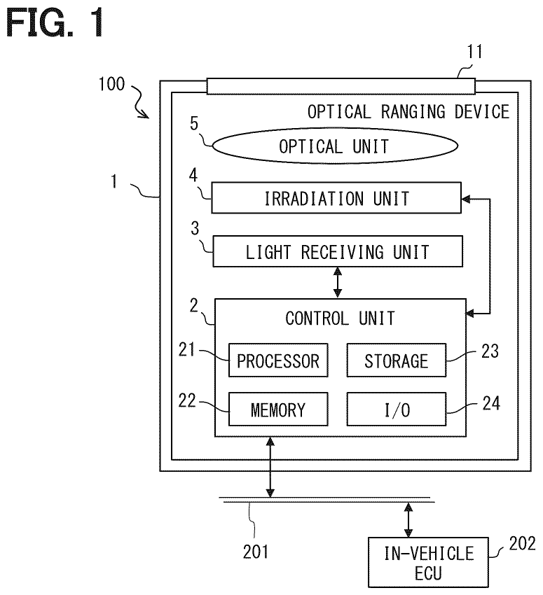

Hereinafter, an embodiment of the present disclosure will be described with reference to the drawings. An optical ranging device 100 illustrated in FIG. 1 is a device that measures a distance to an object on the basis of a round-trip time of light to a target. That is, the optical ranging device 100 generates a range image as data indicating a distance measurement result, on the basis of a time from emission of sensing light having a predetermined wavelength to reception of reflected light corresponding to the sensing light (so-called time of flight (ToF)). The range image includes a plurality of pixels corresponding to a direction to be detected. A value of each pixel included in the range image is data indicating a distance to an object in a direction corresponding to the pixel. Such an optical ranging device 100 is also called light detection and ranging/laser imaging detection and ranging (LiDAR).

The optical ranging device 100 is used mounted on a vehicle as a mobile body. The optical ranging device 100 may be used disposed on a front portion, left and right side portions, rear portion, roof, or the like of the vehicle. Hereinafter, an ego vehicle refers to a vehicle to which the optical ranging device 100 is attached. In the present disclosure, a target refers to various objects that may reflect sensing light. The target may be a feature, a mobile body, or the like, such as another vehicle, a pedestrian, a median strip, or a guardrail, independent of the ego vehicle, and may be an obstacle in traveling control of the vehicle.

The optical ranging device 100 is configured as a kind of flash-type LiDAR that emits diffused sensing light at a time toward an angular range corresponding to a detection range. A wavelength of light used for object detection by the optical ranging device 100 (that is, sensing light) can adopt any value. The sensing light may be infrared light. Another aspect of the sensing light may be visible light. The sensing light may be light in a bandwidth of 900 nm±50 nm that is general for laser light. An irradiation unit 4 may be configured to output laser light having a wavelength of 1400 nm or more, such as 1550 nm. According to the configuration in which an electromagnetic wave of 1400 nm or more is adopted as the sensing light, resistance to white noise from the sunlight or the like (for example, signal-to-noise ratio) is easily increased.

As illustrated in FIG. 1, the optical ranging device 100 is used connected to an in-vehicle ECU 202 via an in-vehicle network 201. The ECU in the present disclosure is an abbreviation of an electronic control unit, and means an electronic control device. The in-vehicle network 201 is a local area network (LAN) constructed in the vehicle. As a LAN standard, a controller area network (CAN is a registered trademark), Ethernet (registered trademark), or the like can be adopted. It is needless to say that the optical ranging device 100 may be directly connected to some sensors/ECUs mounted on the ego vehicle by using a dedicated communication line.

The in-vehicle ECU 202 is an arbitrary ECU mounted on the ego vehicle. The optical ranging device 100 is used connected to a drive assist ECU and the like. The drive assist ECU is an ECU that executes processing of assisting a driving operation of a driver. The drive assist ECU notifies the driver of a collision with another mobile body or a stationary object on the basis of a result of detection by the optical ranging device 100. The drive assist ECU may be an ECU that performs not only information presentation, but also automatic braking control or steering according to a result of detection by the optical ranging device 100. Another mobile body refers to a pedestrian, another vehicle, a cyclist, or the like. The drive assist ECU may be an automatic operation device that causes the vehicle to autonomously travel to a preset destination.

As illustrated in FIG. 1, the optical ranging device 100 includes a housing 1, a control unit 2, a light receiving unit 3, the irradiation unit 4, and an optical unit 5. The housing 1 is configured to accommodate the control unit 2, the light receiving unit 3, the irradiation unit 4, and the optical unit 5. At a back of the irradiation unit 4, the light receiving unit 3 is disposed so as to overlap the irradiation unit 4, in other words, so as to face the irradiation unit 4. The back of the irradiation unit 4 refers to a side opposite to an irradiation direction of the sensing light. In the present disclosure, an upward direction and a forward direction for the configuration, such as the light receiving unit 3 and the irradiation unit 4, accommodated in the housing 1 correspond to the irradiation direction of the sensing light unless otherwise noted. A downward direction and a rear side (back) for the configuration accommodated in the housing 1 refer to directions opposite to the irradiation direction. The irradiation direction of the sensing light serves as a reference in describing a positional relationship of members. The irradiation direction can be rephrased as a traveling direction of the sensing light. The housing 1 is provided with a window portion 11 for emitting the sensing light to outside. The window portion 11 is implemented by using a translucent material that is a material transparent to the sensing light. The translucent material is glass, optical plastic, or the like. The optical plastic is a colorless and transparent polycarbonate resin (PC), an acrylic resin (PMMA), or the like. The translucent material is not necessarily colorless and transparent, and is only required to have a characteristic of transmitting sensing light. The window portion 11 may also function as a window for the light receiving unit 3 to receive reflected light from the target. The reflected light is sensing light reflected by the target and returned. The window portion 11 may also be referred to as a housing opening, an optical window, or the like.

The control unit 2 controls operation of the optical ranging device 100. The control unit 2 inputs to the irradiation unit 4 a signal related to an irradiation setting of the sensing light. The control unit 2 acquires from the light receiving unit 3 pulse information of a light reception pulse corresponding to the reflected light. The control unit 2 is implemented by using a processor 21, a random access memory (RAM) 22, and a storage 23. The control unit 2 includes a digital signal processor (DSP), a central processing unit (CPU), and the like as the processor 21. Various functions of the control unit 2 are implemented by the processor 21 executing programs stored in the storage 23. Details of functions of the control unit 2 will be separately described later.

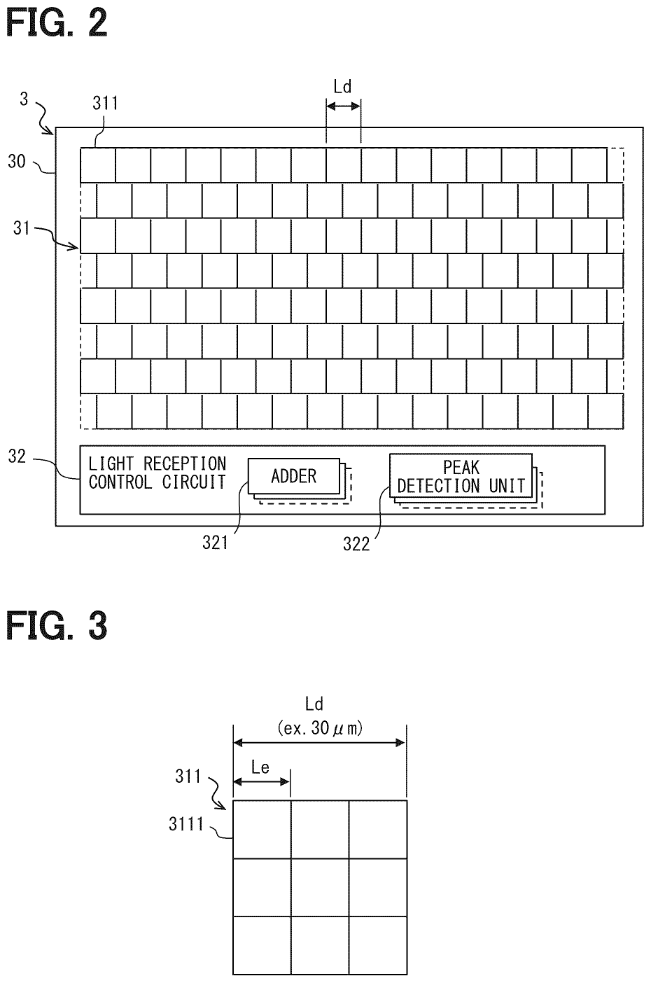

As illustrated in FIG. 2, the light receiving unit 3 is a module in which a light-receiving array unit 31 and a light reception control circuit 32 are formed on a light receiving substrate 30 having a plate shape. The light receiving substrate 30 is a plate-shaped member made of a dielectric material such as glass epoxy resin. A part or all of the light receiving substrate 30 may be configured as a single-sided/double-sided/multilayer circuit board. Of the light receiving substrate 30, the light-receiving array unit 31 refers to a portion where detectors 311 are arranged in a matrix. The detectors 311 output electric signals in response to incidence of the reflected light from an object.

The plurality of detectors 311 is arranged in a two-dimensional matrix. The matrix here refers to a form in which an array arranged at regular intervals in a horizontal direction is defined as one row, and a plurality of rows is arranged in a vertical direction according to a predetermined regularity. In the present embodiment, as an example, the plurality of detectors 311 is arranged in a staggered manner. The staggered arrangement means an arrangement pattern in which lateral positions of elements are shifted for each row while the intervals between the elements in each row are constant. In other words, in the staggered arrangement, when the arrangement has multiple rows, each element in a row is positioned between two elements in the adjacent row. In still other words, the staggered arrangement can also be understood as a form in which elements are arranged at intersections of diagonal lines. Therefore, the state in which the detectors 311 are arranged in a staggered manner corresponds to a state in which the lateral positions of the detectors 311 are regularly shifted for each row. It is needless to say that the plurality of detectors 311 may be arranged in a lattice pattern. In the present embodiment, intervals between the detectors 311 are substantially 0, and the detectors 311 are arranged without a gap in the light-receiving array unit 31. As another example, an interval of a predetermined amount, such as 5 μm to 10 μm, may be formed between the detectors 311. One detector 311 corresponds to one pixel included in the range image.

As illustrated in FIG. 3, the detector 311 includes nine light receiving elements 3111 arranged in a 3×3 matrix. That is, macroscopically, the light-receiving array unit 31 corresponds to a configuration in which a large number of light receiving elements 3111 are arranged in a matrix. The light-receiving array unit 31 may be configured as silicon photo-multipliers (SiPMs) in which a plurality of light receiving elements 3111 is arranged in an array. The detector 311 can be understood as a group obtained by virtually/logically classifying the light receiving elements 3111 arranged in a matrix with a predetermined shape pattern. In the drawing, Ld represents a size of one detector 311, and Le represents a size of one light receiving element 3111. The light receiving element 3111 has, for example, a square shape of 10 μm on a side. Accordingly, the detector 311 has a square shape of about 30 μm on a side. The light receiving elements 3111 may be arranged in a staggered manner on the light receiving substrate 30.

The light receiving element 3111 is a single photon avalanche diode (SPAD). The SPAD is a type of avalanche photodiode. The SPAD operates when a voltage higher than a breakdown voltage is applied as a reverse bias voltage. The light receiving element 3111 includes a quenching circuit connected in series to the SPAD. The quenching circuit may include a resistive element (so-called quenching resistor) having a predetermined resistance value, a MOSFET, or the like. The light receiving element 3111 detects a voltage change when the SPAD is broken down by incidence of a photon and outputs a digital pulse (hereinafter, a pulse signal) having a predetermined pulse width. The detector 311 includes the nine light receiving elements 3111, and thus may output zero to nine pulse signals in parallel according to intensity of received light.

it is needless to say that the number of light receiving elements 3111 included in one pixel/detector 311 is not limited to 9 (3×3), and may be 4 (2×2), 16 (4×4), 25 (5×5), 64 (8×8), or the like. The shape of the detector 311 is not limited to a square shape, and may be a rectangular shape having 18 (6×3) light receiving elements 3111, for example. The number of rows and the number of columns of the light receiving elements 3111 included in the detector 311 may be different. The more the number of light receiving elements 3111 included in the detector 311, the larger amount of information of one element (that is, pixel) included in the range image, and therefore the range image with higher accuracy and resolution is obtained. The light receiving element 3111 may be an element other than the SPAD. The light receiving element 3111 may be a multi-pixel photon counter (MPPC) (Registered trademark) or a photomultiplier tube (PMT).

In the present disclosure, a group of the plurality of light receiving elements 3111 corresponding to one pixel is also referred to as a pixel group. The individual pixel groups correspond to the detector 311 described above. The detector 311 corresponds to a group of the light receiving elements 3111 arranged in a lattice pattern or a diagonal lattice pattern in a predetermined size such as 3 rows and 3 columns. In the present embodiment, individual pixel groups are set so as not to overlap each other. As another aspect, each pixel group may be set to overlap another adjacent pixel group. According to the configuration in which each pixel group partially shares the light receiving elements 3111, the number of detectors 311, and thus the number of pixels, can be increased with the fixed number of light receiving elements 3111.

The light reception control circuit 32 is a circuit module that controls operation of the light receiving unit 3. On the basis of a signal from the control unit 2, the light reception control circuit 32 controls a conduction state of each detector 311, that is actually each light receiving element 3111. On the basis of signals from the control unit 2, the light reception control circuit 32 energizes each light receiving element 3111 to switch to a light reception state in which reflected light can be detected.

The light reception control circuit 32 uses output signals from the light receiving elements 3111 as processing function units and includes adders 321 and peak detection units 322. The adder 321 is configured to add the number of the pulse signals output from the plurality of light receiving elements 3111 included in one detector 311. The adder 321 is provided for each pixel, in other words, for each detector 311. Each adder 321 may be implemented as software or hardware. The plurality of adders 321 may be implemented by using a field-programmable gate array (FPGA), an application specific integrated circuit (ASIC), or the like. Output from the respective adders 321 indicates the number of responses from the light receiving elements 3111 corresponding to the adder 321, in other words, received-light intensity of each detector 311. In the present disclosure, the output from the adders 321 is also referred to as received-light intensity or a level value.

As described above, pulse signals of the number corresponding to an amount of incident light are output from each of the plurality of light receiving elements 3111 included in the detector 311. Therefore, when the reflected light from the target is incident on the detector 311, the number of pulse signals output from the detector 311 per unit time, that is, a pulse rate significantly increases. Accordingly, an output level of the adder 321 corresponding to the detector 311 may also sharply increase at a timing corresponding to reception of the reflected light. For convenience, a series of signals of which peaks exceed a predetermined level is referred to as a light reception pulse.

The peak detection unit 322 is configured to detect a peak of the light reception pulse on the basis of time-series data of the received-light intensity of each detector 311. The peak detection unit 322 is provided for each detector 311, in other words, for each pixel/each adder 321. The peak corresponds to a time at which the received-light intensity starts to decrease after having increased. The peak detection unit 322 generates a histogram configured to indicate the received-light intensity for each time. The generated histogram is held in a memory or RAM 22 (not illustrated) in a predetermined format, such as a table.

The peak detection unit 322 detects the light reception pulse and the peak thereof on the basis of the time-series data (histogram) of the received-light intensity, and acquires pulse information associated with the peak. The pulse information includes a peak intensity, a leading edge determination time, a peak arrival time, and a pulse width. The peak intensity indicates an intensity at a time point when intensity in a waveform reaches a maximum (that is, a peak value). The peak intensity corresponds to a value immediately before the received-light intensity starts to decrease, in other words, the intensity at a time when an inclination becomes 0. The inclination here corresponds to a time rate of change of the received-light intensity. If intensity of the light reception pulse reaches an upper limit value of measurement, the upper limit value of measurement is the peak intensity. The upper limit value of measurement corresponds to a maximum value of a range of values that can be output by the adder 321. The upper limit value of measurement corresponds to the number of light receiving elements 3111 included in the detector 311. Assuming that the number of light receiving elements 3111 included in one detector 311 is nine, a sensor upper limit value is 9.

The leading edge determination time is a time elapsed from when the sensing light is emitted to when the received-light intensity reaches a determination threshold value. The determination threshold value is set to a value obtained by multiplying actually observed peak intensity by a predetermined coefficient k. As the value of the coefficient k, for example, 0.45, 0.50, 0.55, 0.60, or the like is adopted. Here, as an example, k=0.55 (corresponding to 55%) is set. The determination threshold value is a parameter that defines a so-called mesial point at which the received-light intensity is half of the peak. The mesial point here is not limited to a point that is exactly 50%, and may be a point that is 45%, 60%, or the like as described above.

The received-light intensity output from the light reception control circuit 32 may include a stationary noise component that is stationary noise due to the sunlight or the like. The peak detection unit 322 may determine the peak intensity, a leading edge position/trailing edge position, and the like on the basis of the time-series data of corrected received-light intensity obtained by removing the stationary noise component from a value output from the light reception control circuit 32. Magnitude of the stationary noise component can be determined on the basis of the received-light intensity before the sensing light is emitted.

The peak arrival time is a time elapsed from when the sensing light is emitted to when the peak intensity is observed. Assuming that the peak detected by the peak detection unit 322 corresponds to the reflected light from the target, the peak arrival time corresponding to the peak corresponds to a round-trip flight time (that is, ToF) to the target. Thus, the control unit 2 can calculate a distance to the target for each pixel by multiplying the peak arrival time by C/2 (C is speed of light). When a true-peak is unclear due to the received-light intensity reaching the upper limit value of measurement, the peak detection unit 322 can adopt an intermediate time positioned in the middle of a period in which the received-light intensity reaches the upper limit, as the peak arrival time.

The pulse width is a parameter indicating a width of the light reception pulse. The pulse width corresponds to a length of time during which the received-light intensity is equal to or greater than the determination threshold value. That is, the pulse width may be specified by subtracting the leading edge determination time from a trailing edge determination time. The trailing edge determination time is a time elapsed from when the sensing light is emitted to when the received-light intensity falls below the determination threshold value after the peak. The peak detection unit 322 does not necessarily generate and output all the parameters described above as pulse information. The peak detection unit 322 is only required to be configured to acquire a parameter necessary for distance calculation processing, among all the parameters described above.

Such a light reception control circuit 32 is formed on a light receiving surface. Of two surfaces of the light receiving substrate 30, the light receiving surface is a surface having a light-receiving array unit 31 formed thereon. A part or all of the light reception control circuit 32 may be formed on a light-receiving back surface that is a surface opposite to the light receiving surface. The light reception control circuit 32 may be formed on a substrate physically different from the substrate on which the light-receiving array unit 31 is formed. The light reception control circuit 32 outputs, to the control unit 2, pulse information for each detector 311.

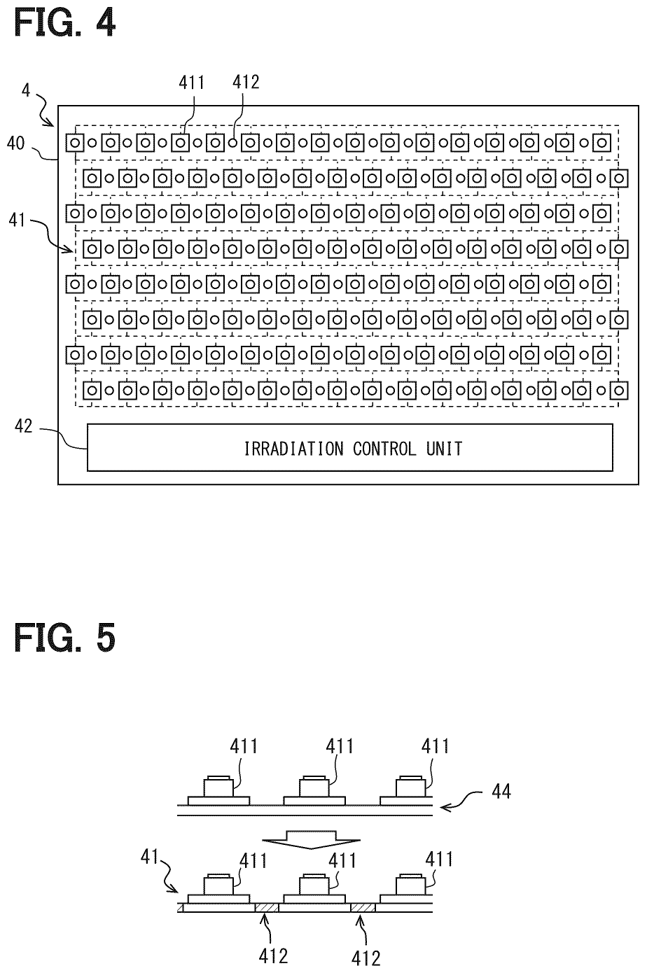

As illustrated in FIG. 4, an irradiation unit 4 is a module in which an irradiation array unit 41 and an irradiation control circuit 42 are formed on an irradiation substrate 40 having a plate shape. The irradiation substrate 40 is implemented with an opaque resin such as a glass epoxy resin, as an example. The irradiation substrate 40 may be implemented with a translucent material such as acrylic.

The irradiation unit 4 is disposed above the light receiving unit 3 such that the irradiation array unit 41 overlaps the light-receiving array unit 31. That is, the irradiation array unit 41 is arranged above the light-receiving array unit 31. Broken lines in FIG. 4 denote positions of the detectors 311.

In the irradiation substrate 40, the irradiation array unit 41 is a portion on which light emitting elements 411 are arranged in a matrix. On the irradiation array unit 41, the plurality of light emitting elements 411 is arranged in a staggered manner. The light emitting element 411 may be a vertical-cavity surface-emitting laser (VCSEL). The light emitting element 411 is not limited to the VCSEL, and may be an edge emitting laser (EEL). In that case, the irradiation array unit 41 may have a configuration in which EELs are retrofitted to a surface of an aperture array 43 in a matrix. The VCSEL has an advantage of being easier to manufacture in a matrix than the EEL.

Apertures 412 are also disposed on the irradiation array unit 41. The apertures 412 are optical openings for the sensing light to pass therethrough. The apertures 412 are arranged in a staggered manner by using regions positioned between the light emitting elements 411. That is, the irradiation array unit 41 has a configuration in which the light emitting elements 411 and the apertures 412 are alternately arranged.

As illustrated in FIG. 5, such an irradiation array unit 41 may be implemented by forming through-holes as the apertures 412 in a matrix form with respect to a VCSEL array 44 on which VCSELs as the light emitting elements 411 are arranged in a matrix. The aperture 412 may be implemented by laser processing, etching, or the like. The VCSEL array 44 may correspond to an irradiation module. Because the irradiation array unit 41 includes the plurality of apertures 412, the irradiation array unit 41 corresponds to an aperture module.

As a method for manufacturing the VCSEL array 44, various methods such as a method disclosed in Patent Literature 1 (especially in FIG. 4) can be used. A general VCSEL manufacturing process may include (1) an epitaxial growth process, (2) a mask patterning process, (3) a mesa etching process, (4) an oxidation and constriction process, (5) a protection film formation process, and (6) an electrode fabrication process. The epitaxial growth process is a process of forming a laminated structure including a distributed Bragg reflector (DBR) multilayer film including AlGaAs/GaAs layers of a few dozen pairs or more and an active layer on a base material. The mask patterning process is a process of forming a mask pattern for forming an epitaxial layer into a cylindrical shape called mesa. The mesa etching process is a process of forming a mesa with dry etching. The oxidation and constriction process is a process of oxidizing and constricting a specific AlGaAs layer designed in a vicinity of the active layer, by using wet oxidation. The protection film formation process is a process of applying a protection film to a side surface of the mesa. The electrode fabrication process is a process of fabricating an electrode on each of n-type and p-type layers. The VCSEL array 44 of the present disclosure may also be generated by using a general technique.

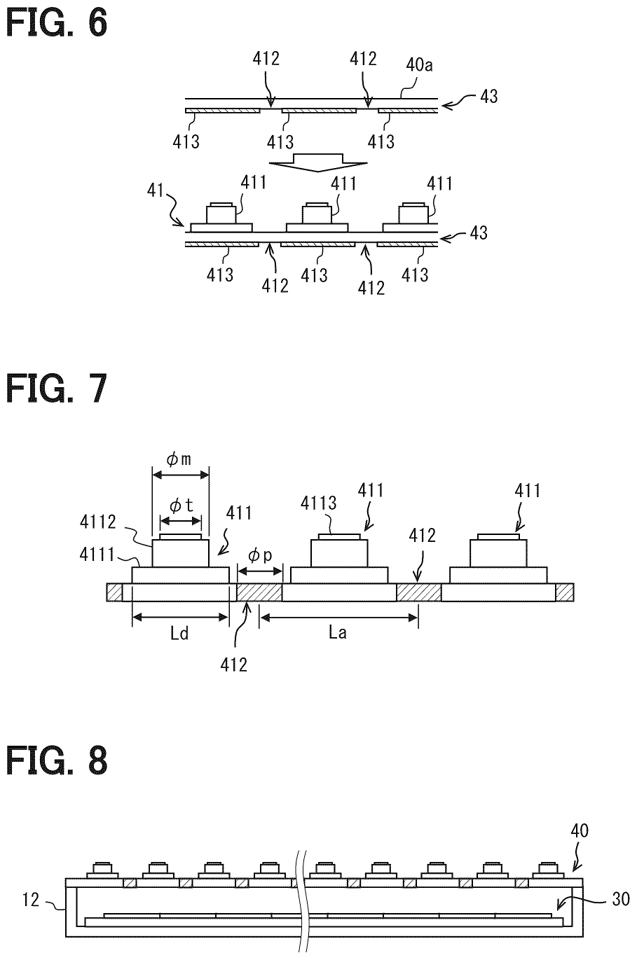

The method for manufacturing the irradiation array unit 41 as described above is an example, and can be appropriately changed. As illustrated in FIG. 6, the irradiation array unit 41 may be manufactured by attaching the plurality of light emitting elements 411 to an upper surface of the aperture array 43 in a matrix by using a micro-transfer printing (MTP) technique or the like. Such an irradiation array unit 41 corresponds to a configuration in which the light emitting elements 411 are implemented between the apertures 412, on the surface of the aperture array 43, which is a plate-shaped member in which the apertures 412 are provided in a matrix. Accordingly, the aperture array 43 may correspond to the irradiation substrate 40. From another viewpoint, the irradiation array unit 41 can also be understood as a configuration in which the apertures 412 are arranged between VCSELs adjacent in a row direction in the VCSEL array 44.

The aperture array 43 may be a plate-shaped member in which light-shielding films 413 are partially provided on a surface of the base material 40a that transmits the sensing light. The aperture array 43 may be manufactured by adding resistor films to the positions where the apertures 412 are to be formed on the base material 40a, forming the light-shielding films 413, and then removing resistor films. Holes provided in a non-translucent plate or portions of a translucent plate-shaped member where the light-shielding films 413 are not formed correspond to the apertures 412. The light-shielding films 413 may be conductive films. The light-shielding films 413 may be implemented by using conductive layers.

It is needless to say that the aperture array 43 may have a configuration in which a plurality of through-holes as the apertures 412 is provided in an opaque base material 40b that does not transmit the sensing light. The aperture 412 is only required to have a macroscopically point-shaped configuration for the sensing light to pass therethrough. The apertures 412 can be referred to as openings or light transmission holes (optical holes). The optical hole is a structure for the sensing light to pass therethrough, and may be filled with a translucent material such as glass or acrylic resin. In the present disclosure, the portions of the aperture array 43 where the apertures 412 are not formed are also referred to as light-shielding areas. Portions where the light-shielding films 413 are provided and portions where the through-holes as the apertures 412 are not formed correspond to the light-shielding areas. The light emitting elements 411 are disposed on the light-shielding areas.

The aperture 412 has a circular shape. A diameter (φp in FIG. 7) of the aperture 412 is set to 10 μm or the like. Here, the circular shape includes not only a perfect circle but also an elliptical shape. The plurality of apertures 412 is disposed at positions overlapping with central portions of the detectors 311 when viewed from the irradiation direction, for example. That is, the number of apertures 412 formed in the irradiation array unit 41 is the same as the number of detectors 311. Similarly to the detectors 311, the plurality of apertures 412 is arranged in a staggered manner. An arrangement interval (La) of the apertures 412 is set to, for example, 30 μm. The arrangement interval of the apertures 412 corresponds to a center-to-center distance of the apertures 412 arranged in the row direction. The arrangement interval of the apertures 412 can be appropriately changed according to dimensions of the detectors 311.

According to the configuration in which the apertures 412 are disposed in front of the detectors 311, it is possible to reduce chances that the detectors 311 react to noise. That is, by providing the apertures 412, an effect of improving a signal-to-noise ratio can be expected. The signal-to-noise ratio is a parameter indicating a ratio or difference between a signal and noise, and may also be expressed as a signal-to-noise ratio (SNR), an SN ratio, S/N, or the like. A larger signal-to-noise ratio indicates better quality. The larger the diameter of the aperture 412 is, the higher light receiving sensitivity, and the more probable that the detector 311 responds to noise.

The diameter of the aperture 412 may be appropriately designed in a range of, for example, 3 μm to 20 μm so as to obtain desired performance. The aperture 412 is formed to be as large as or smaller than the light emitting element 411. A shape of the aperture 412 is not limited to a circular shape, and may be a rectangular shape, a hexagonal shape, an octagonal shape, or the like. The rectangular shape includes a rhombus shape, a square shape, and the like. Because the aperture 412 has a circular or polygonal shape having a dimension of 20 μm or less, the aperture 412 can be understood as a point-shaped/dotted opening from a macroscopic viewpoint. The individual apertures 412 are not linear (slit). The point-shaped state according to the present disclosure also includes a state having a certain area, such as a circle having a diameter of 3 μm or more and 20 μm or less, and a polygon having an equivalent area.

The plurality of light emitting elements 411 is also arranged in a staggered manner on the irradiation array unit 41. The light emitting element 411 may be formed at a midpoint between the two apertures 412 arranged in the row direction. The light emitting elements 411 are arranged side by side in the row direction at an interval (for example, 30 μm) corresponding to the interval of the apertures 412. The light emitting elements 411 are disposed so as to sandwich one aperture 412. Two light emitting elements 411 sandwiching one aperture 412 are at point-symmetrical positions with respect to the aperture 412. The configuration corresponds to an example of a configuration in which at least one light emitting element 411 is disposed within 60 μm from the aperture 412.

The light emitting element 411 includes a base portion 4111 having a plate shape and a mesa portion 4112 having a cylindrical shape. A light emitting region 4113 is formed at an upper end portion of the mesa portion 4112. The base portion 4111 is formed in a square shape with one side set to, for example, 16 μm. A diameter (φm) of the mesa portion 4112 may be 10 μm or the like. The light emitting region 4113 has a circular shape and has a diameter (φt) set to 8 μm or the like. Values of various dimensions are examples and can be appropriately changed.

Each light emitting element 411 forms a beam having a steep, conical shape. A beam spread angle is an angle at which laser light emitted from each light emitting element 411 spreads. The beam spread angle may be set to 10°, 20°, or the like. The beam spread angle is an element corresponding to an apex angle of the conical beam, and is also referred to as a beam divergence angle or the like. The beam spread angle and the irradiation direction of each of the light emitting elements 411 are designed such that beam spots of adjacent light emitting elements 411 start to overlap each other in front of a predetermined distance (for example, 100 m). The irradiation direction of each light emitting element 411 may be adjusted by the optical unit 5.

The irradiation control circuit 42 is a circuit module that controls operation of the light emitting elements 411. The irradiation control circuit 42 controls a conduction state of each of the light emitting elements 411 on the basis of signals from the control unit 2. On the basis of commands from the control unit 2, the irradiation control circuit 42 causes all the light emitting elements 411 to emit sensing light at predetermined irradiation intervals.

The irradiation control circuit 42 may adjust a pulse width, irradiation intensity, irradiation interval, and the like of the sensing light to be emitted to the light emitting elements 411, on the basis of control signals input from the control unit 2. The irradiation intensity corresponds to a peak height (so-called peak power) of pulsed light output as the sensing light. In order to be distinguished from sensing light received as reflected light, the sensing light emitted from the irradiation unit 4 is also referred to as irradiation light. The pulse width of the irradiation light is set to, for example, 5 nanoseconds. It is needless to say that the pulse width of the irradiation light may be 20 nanoseconds, 10 nanoseconds, or 1 nanosecond. The pulse width of the irradiation light may be set to a value of less than 1 nanosecond, such as 50 picoseconds, 100 picoseconds, or 200 picoseconds. The irradiation control circuit 42 may be configured to be able to drive the light emitting elements 411 included in the irradiation array unit 41 row by row or column by column. The irradiation control circuit 42 may be configured to be able to individually drive the plurality of light emitting elements 411.

Of two surfaces of the irradiation substrate 40, an array formed surface is a surface having the irradiation array unit 41 formed thereon. The irradiation control circuit 42 is formed on the array formed surface. On the array formed surface, the irradiation control circuit 42 is formed around the irradiation array unit 41. A part or all of the irradiation control circuit 42 may be formed on a non-array-formed surface that is a surface opposite to the array formed surface. The irradiation control circuit 42 may be formed on a substrate physically different from the substrate on which the irradiation array unit 41 is formed. That is, the irradiation substrate 40 illustrated in FIG. 4 may be implemented by being divided into two substrates.

The light receiving unit 3 and the irradiation unit 4 described above may be fitted to the housing 1 in a packaged form as illustrated in FIG. 8. In the package illustrated in FIG. 8, the light receiving unit 3 is fixed in an inner lower case 12 having a substantially box shape and an open upper portion. The irradiation substrate 40 is fixed to an upper end portion of the inner lower case 12 so as to close an opening of the inner lower case 12. According to another aspect, the configuration corresponds to a configuration in which the inner lower case 12 housing the light receiving substrate 30 is fitted to a lower surface of the irradiation substrate 40.

The optical unit 5 has a configuration mainly including lenses. The optical unit 5 plays a role of adjusting a traveling direction of light emitted from each light emitting element 411 and focusing (i.e., condensing) reflected light toward the light-receiving array unit 31. The optical unit 5 may play a role of spreading and outputting the sensing light emitted from each light emitting element 411 to a desired angle of view. The optical unit 5 is disposed between the window portion 11 and the irradiation unit 4. In other words, the optical unit 5 is disposed above the irradiation unit 4. In the optical ranging device 100 of the present disclosure, a common optical unit 5 is used between an irradiation system and a light receiving system, on assumption that the irradiation array unit 41 and the light-receiving array unit 31 overlap and are arranged close to each other. As a result, the optical ranging device 100 can be downsized.

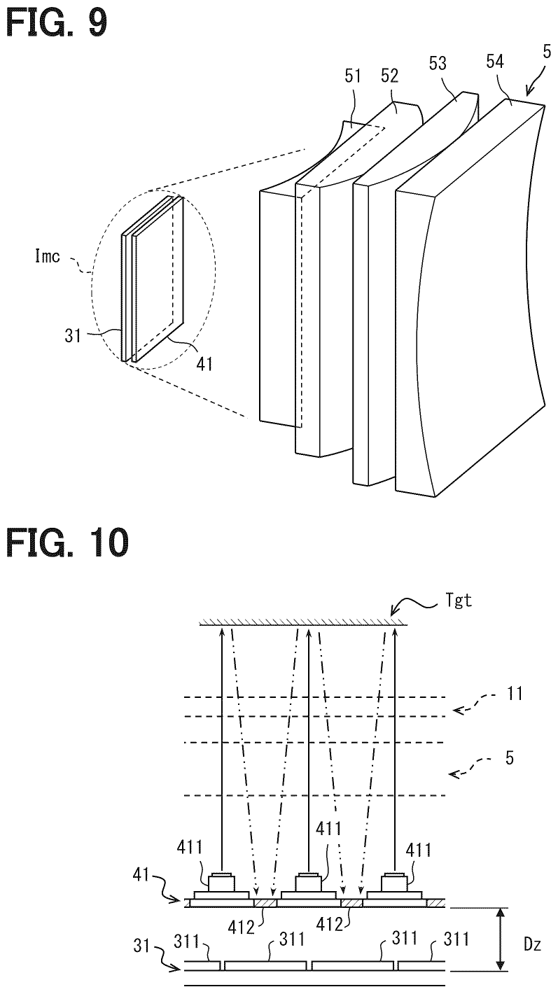

In the optical unit 5, a plurality of types of lenses may be combined. As illustrated in FIG. 9, the optical unit 5 has a configuration in which a first plano-concave cylindrical lens 51, a first cylindrical lens 52, a second convex cylindrical lens 53, and a second plano-concave cylindrical lens 54 are arranged in this order along the irradiation direction.

The optical unit 5 is configured such that a composite focal plane is positioned on a substrate surface of the irradiation array unit 41. The position of the composite focal plane is determined by curvature of the lenses included in the optical unit 5. The optical unit 5 is designed to form an image circle Imc enclosing the irradiation array unit 41. In other words, the irradiation array unit 41 is disposed inside the image circle Imc of the optical unit 5. The image circle Imc is an area in which light that has passed through the lens forms an image, and may be determined by focal lengths and maximum apertures of the lenses that constitute the optical unit 5. The optical unit 5 is designed to form a depth of field (DOF) according to a distance range to be detected.

A part of the first plano-concave cylindrical lens 51, first cylindrical lens 52, second convex cylindrical lens 53, and second plano-concave cylindrical lens 54 described above may be omitted. The optical unit 5 may include only one lens. The optical unit 5 may be implemented by using a lens other than the lenses exemplified in FIG. 9. The optical unit 5 may be a Fresnel lens or the like that forms a desired focal length. The optical unit 5 may have an optical configuration disclosed in Patent Literature 2. The light receiving unit 3 and the irradiation unit 4 are disposed within a focal depth of the optical unit 5. That is, an interval (Dz) between the light receiving unit 3 and the irradiation unit 4 is set to a value corresponding to the focal depth of the optical unit 5. In a case where an axial distance of the focal depth formed by the optical unit 5 is 10 mm or the like, the interval between the light receiving unit 3 and the irradiation unit 4 may be set to 10 mm or less, for example, 6 mm or the like.

As illustrated in FIG. 10, the sensing light emitted from the light emitting elements 411 is emitted to outside of the housing 1 via the optical unit 5 and the window portion 11, and then reflected by the object and returns. Tgt in the drawing denotes a target, that is, the object that reflects sensing light. The reflected light from the target travels toward the irradiation array unit 41 via the window portion 11 and the optical unit 5. The reflected light that has reached a surface of the irradiation substrate 40 is received by the detectors 311 via the apertures 412. Dash-dot-dot lines in the drawing conceptually denote paths of the reflected light.

As illustrated in FIG. 10, according to the configuration in which the apertures 412 are arranged in a staggered manner, the reflected light corresponding to the sensing light emitted from light emitting elements 411 above, below, on the left, and on the right of one aperture 412 may be input to the aperture 412. Here, the above and below indicate upper and lower sides of a surface of paper illustrating FIGS. 3 and 4, and correspond to a column direction of the matrix. That is, the reflected light corresponding to the sensing light emitted from four light emitting elements 411 surrounding one aperture 412 may be input to the aperture 412.

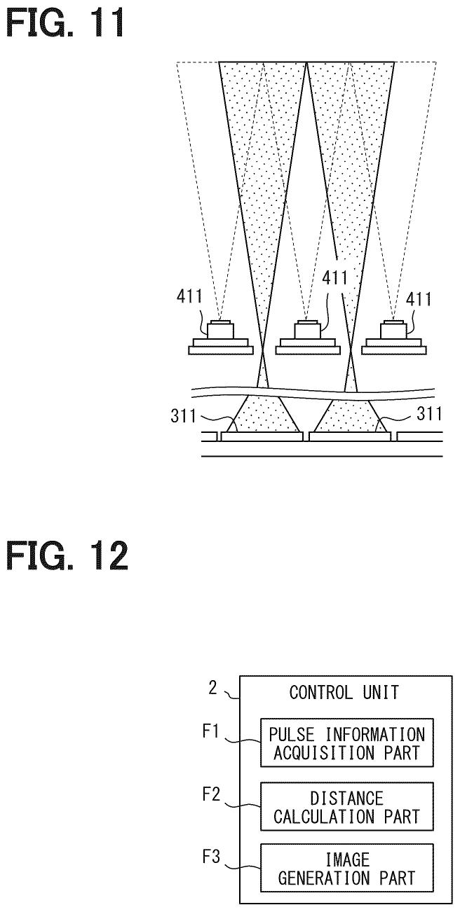

The reflected light that has entered the aperture 412 is received by a detector 311 below the aperture 412. The aperture 412 and the optical unit 5 define a field of views of the detectors 311. FIG. 11 is a diagram schematically illustrating a relation between fields of view of the detectors 311 and beams from the light emitting elements 411. Areas with dotted hatch pattern in FIG. 11 denote a field of view of each detector 311. As illustrated in FIG. 11, each detector 311 operates to mainly detect the sensing light emitted from two/four light emitting elements 411 adjacent to an aperture 412 above the detector 311. In the present disclosure, a light emitting element 411 at a position sandwiching an aperture 412 above a certain detector 311 in the row direction and column direction as viewed from a certain detector 311 is also referred to as an adjacent light emitting element.

The control unit 2 outputs to the irradiation control circuit 42 a signal that instructs emission of sensing light, and inputs to the light receiving unit 3 a predetermined control signal, thereby driving each detector 311 for a certain period of time. It is needless to say that, as another aspect, each detector 311 may be configured to always maintain a driving state capable of responding according to intensity of the incident light.

The control unit 2 provides functions corresponding to various functional blocks illustrated in FIG. 12 by executing a program saved in the storage 23. That is, the control unit 2 includes a pulse information acquisition part F1, a distance calculation part F2, and an image generation part F3 as the functional blocks.

The pulse information acquisition part F1 acquires pulse information from a peak detection unit 322 corresponding to each pixel. That is, the pulse information acquisition part F1 acquires pulse information for each pixel. Each pixel may be distinguished by a pixel number that is a unique number for each pixel. Some of the functions of the peak detection unit 322 may be included in the pulse information acquisition part F1. The peak detection unit 322 may be configured to execute only peak detection. The pulse information acquisition part F1 may execute processing of extracting a feature value of the light reception pulse including a detected peak. Functional arrangement can be appropriately changed.

The distance calculation part F2 generates a distance value for each pixel on the basis of the feature value of the light reception pulse for each pixel observed by the emission of the sensing light. The distance calculation part F2 may calculate, as the distance value, a value obtained by subtracting a predetermined leading edge correction value from a value obtained by multiplying the observed peak arrival time by half of the light speed. The leading edge correction value is a parameter for canceling (correcting) a response delay of the circuit. The distance calculation part F2 may calculate the distance value by using the leading edge determination time instead of the peak arrival time. The distance calculation part F2 may correct the distance value using the pulse width.

The image generation part F3 generates, as the range image, a data set in which the distance value for each pixel calculated by the distance calculation part F2 is assigned as an element value of each pixel. The image generation part F3 may generate intensity image data. The image data is a data set in which peak intensity detected by the peak detection unit 322 is associated with each pixel. The image generation part F3 may generate image data in which each pixel includes distance information and intensity information. The range image generated by the image generation part F3 is output toward the drive assist ECU and the like.

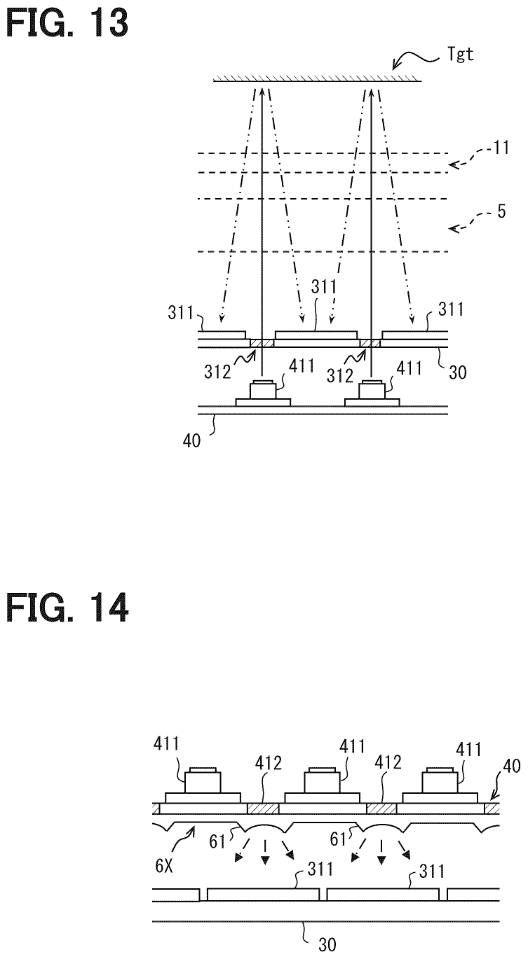

Here, effects of a proposed configuration, which is the configuration according to the present disclosure, will be described by using a configuration in which the irradiation array unit 41 is disposed behind the light-receiving array unit 31 as illustrated in FIG. 13, as a comparative configuration.

In the comparative configuration illustrated in FIG. 13, the irradiation array unit 41 is disposed behind the light-receiving array unit 31. Therefore, it is necessary to form, in the light-receiving array unit 31, openings 312 for the irradiation light to pass therethrough, at positions overlapping the light emitting elements 411. As a result, the detector 311 and the light receiving element 3111 are arranged sparsely. The irradiation light from the light emitting elements 411 is directed to outside of the housing through the openings 312 provided in the light-receiving array unit 31. If the openings 312 are set large so as not to hinder emission of the irradiation light, the light receiving elements 3111 are arranged at more sparse intervals. If the openings 312 are set small, part of the irradiation light is blocked by the light-receiving array unit 31, and the irradiation intensity may attenuate. Because the intensity itself is high immediately after the irradiation, an effect of the attenuation immediately after the irradiation may relatively shorten the detection distance.

Meanwhile, according to the proposed configuration, the irradiation array unit 41 is disposed upstream of the light-receiving array unit 31. Therefore, the irradiation light from the light emitting elements 411 is less likely to attenuate in the device. Therefore, according to the proposed configuration, the detection distance can be improved even with the same light emission intensity (power consumption) as compared with the comparative configuration. In addition, as compared with the comparative configuration, according to the proposed configuration, it is not necessary to provide gaps for the irradiation light to pass therethrough, between the light receiving elements 3111. Therefore, the light receiving elements 3111 can be arranged more densely than with the comparative configuration, and spatial resolution can be improved. Here, the spatial resolution refers to ability to distinguish two points that are close in position as two independent points.

According to the above proposed configuration, the sensing light from two light emitting elements 411 adjacent to an aperture 412 positioned above one detector 311 is substantially simultaneously incident on the detector 311. According to the proposed configuration, an effect of improving the signal-to-noise ratio can be expected by increasing amount of light incident on one detector 311.

In the proposed configuration, the optical unit 5 is shared by the irradiation system and the light receiving system. Therefore, the device can be downsized. Alternatively, because a lens in the light receiving system can be omitted, a lens in the optical unit 5 can be enlarged. That is, according to the proposed configuration, an aperture (light focusing amount) of the lens can be increased, and the detection distance and the spatial resolution can be improved. According to the proposed configuration, light focusing capability is improved. Therefore, a dynamic range may also be expanded. As a result, performance of detecting a strongly reflective object, an object at a short distance, and the like may also be improved. The strongly reflective object refers to a reflector plate or the like provided in another vehicle. The short distance may refer to, for example, within 1 m from the window portion 11.

In the proposed configuration, the detectors 311 and the like are arranged in a staggered manner. According to the configuration, the number of detectors 311 in a unit circle can be increased as compared with a case where the detectors 311 are arranged in a regular lattice pattern. As a result, the spatial resolution can be improved.

The embodiments of the present disclosure have been described above. However, the present disclosure is not limited to the above-described embodiments, and various modifications described below are also included in the technical scope of the present disclosure, and various modifications other than the following may be made without departing from the scope of the present disclosure. The following various modifications may be appropriately combined as long as there is no technical contradiction. Unspecified configurations in which two or more modifications are combined are also included in the present disclosure. Members having the same functions as the members described above are denoted by the same reference numerals, and the description thereof may be omitted. If only a part of a configuration is referred to, the above description may be applied to other parts.

The arrangement interval of the apertures 412 does not necessarily need to coincide with the dimensions of the detectors 311. The apertures 412 do not necessarily need to be arranged to coincide with centers of the detectors 311. The apertures 412 may be arranged at positions shifted from the centers of the detectors 311. The size and positions of the detectors 311 may vary depending on how the light receiving elements 3111 are grouped and handled. A setting of a pixel group as the detectors 311 may be changed according to positions of the apertures 412. In the optical ranging device 100, the positions of the apertures 412 may not be designed with reference to the detectors 311, and the detectors 311 may be arranged with reference to the positions of the apertures 412.

As illustrated in FIG. 14, aperture lenses 61 may be arranged below the apertures 412. FIG. 14 illustrates a configuration in which a light-receiving microlens array 6X is attached to the lower surface of the irradiation substrate 40. On the light-receiving microlens array 6X, recesses as the aperture lenses 61 are formed at positions overlapping the apertures 412. The light-receiving microlens array 6X is not necessarily attached to the lower surface of the irradiation substrate 40. The light-receiving microlens array 6X may be fixed to the housing 1 so as to have a predetermined interval from the irradiation substrate 40.

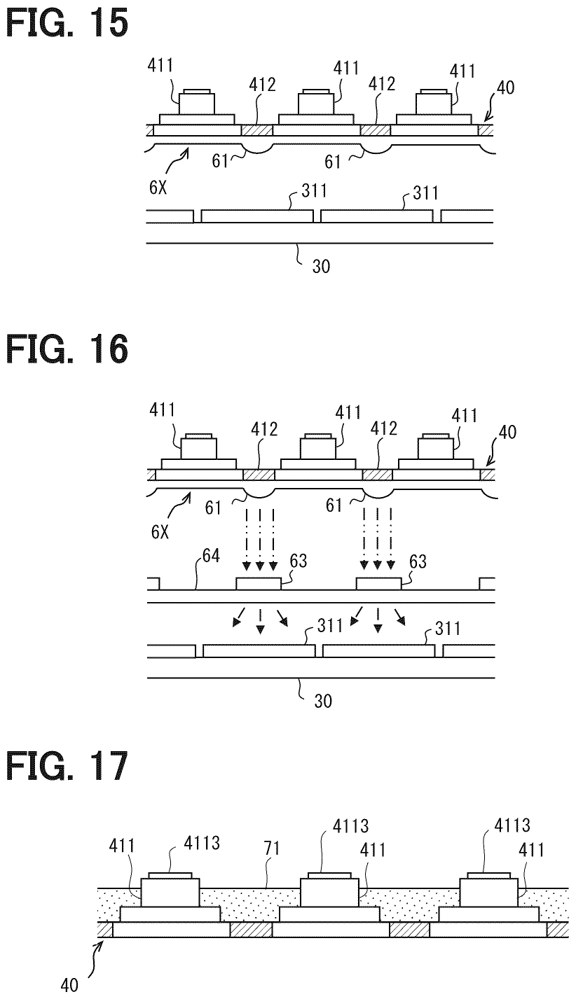

FIG. 14 illustrates an aspect in which the aperture lenses 61 are concave lenses. However, the aperture lenses 61 may be formed as convex lenses as illustrated in FIG. 15. Above the light-receiving array unit 31, a microlens array convex upward may be arranged instead of/together with the aperture lenses 61. The size of each lens that constitutes the microlens array covering the light-receiving array unit 31 may correspond to a size of the light receiving elements 3111.

According to the configuration in which the aperture lenses 61 are provided under the apertures 412 as described above, it may be possible to more efficiently guide to the detector 311 the light that has reached the apertures 412. A shape (curvature or the like) of the aperture lenses 61 may be different depending on a positional relationship between the apertures 412 and the detector 311. The shape of the aperture lenses 61 may be different depending on whether the centers of the detectors 311 are positioned directly below the apertures 412. Each aperture lens 61 is only required to be designed to more efficiently guide the reflected light incident on the aperture 412 to the corresponding detector 311. According to the configuration in which the aperture lenses 61 are provided under of the apertures 412, positional restrictions on the detectors 311 with respect to the apertures 412 can be relaxed, and it is possible to increase flexibility in positions where the detectors 311 are provided.

As illustrated in FIG. 16, diffusion plates 63 may be disposed between the apertures 412 and the detectors 311. The diffusion plate 63 is an optical member that diffuses light arriving from a semi-convex aperture lens 61 toward a detector 311 and outputs the light. The diffusion plate 63 may be a translucent glass/acrylic plate having a surface on which random irregularities are formed. The diffusion plate 63 is disposed immediately below the aperture lens 61, in other words, above the detector 311. The diffusion plate 63 may be disposed for each aperture 412. The plurality of diffusion plates 63 is fixed on a support plate 64 that is a transparent plate-shaped member. The diffusion plates 63 may be integrated with the support plate 64. Separation of the diffusion plate 63 and the detector 311 may be designed on the basis of an optical characteristic (for example, a divergence angle) of the diffusion plate 63 and the dimensions of detector 311, so that the reflected light from the aperture lens 61 reaches corners of the detector 311.

An upper heat conductor 71 may be provided on the irradiation substrate 40, especially around the light emitting elements 411. The upper heat conductor 71 is a member having thermal conductivity. The upper heat conductor 71 is implemented by using a translucent material. The upper heat conductor 71 may have a configuration in a gel/putty form such as silicon. The upper heat conductor 71 in the gel/putty form may be applied to peripheries of the light emitting elements 411 and then cured by irradiation with ultraviolet rays or the like. In FIG. 17 illustrates a configuration in which the upper heat conductor 71 is added so that the light emitting regions 4113 are exposed. However, the present invention is not limited thereto. The upper heat conductor 71 may be added so as to cover the light emitting regions 4113.

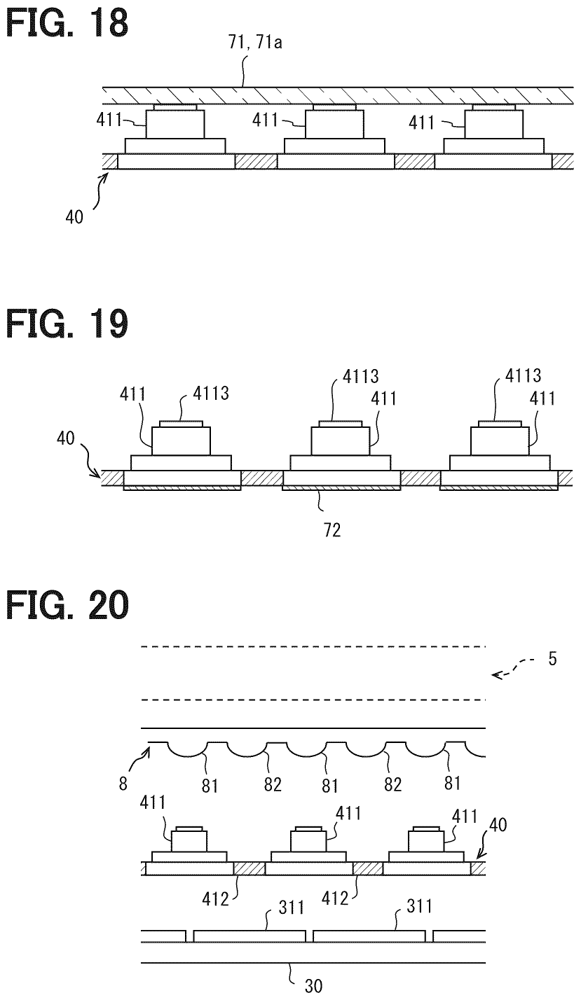

As illustrated in FIG. 18, the upper heat conductor 71 may be a glass plate 71a. The glass plate 71a as the upper heat conductor 71 may be disposed so as to abut on upper ends of the light emitting elements 411. Grease having translucency may be applied between the glass plate 71a and the light emitting regions 4113.

According to the configuration in which the upper heat conductor 71 is added to a top or lateral side of the light emitting elements 411, a rise in temperature of the light emitting elements 411 can be reduced. Accordingly, the irradiation intensity may be increased. If the irradiation intensity can be increased, the detection distance can be further extended.

On the lower surface of the irradiation substrate 40, a lower heat conductor 72 may be applied to a portion positioned on backs of the light emitting elements 411 as illustrated in FIG. 19. The lower heat conductor 72 is a member having thermal conductivity. The lower heat conductor 72 may be a translucent material such as glass, or may be implemented by using a material, such as a metal plate or carbon graphite, that does not transmit sensing light. In a case where the lower heat conductor 72 is implemented by using an opaque material, the lower heat conductor 72 is formed so as not to block the apertures 412. The lower heat conductor 72 may be a thermal conductive sheet in which holes are formed at positions corresponding to the apertures 412. The thermal conductive sheet is attached to a lower surface of the irradiation substrate 40 with an adhesive or the like. The lower heat conductor 72 may be a metal film or the like. The lower heat conductor 72 may be a copper foil or the like patterned on the lower surface of the irradiation substrate 40. In a case where a base material of the VCSEL array 44 is a multi-layer substrate, an inner conductor layer of the multi-layer substrate can be used as the lower heat conductor 72.

The lower heat conductor 72 may be implemented by using a conductor layer of the irradiation substrate 40 or the like. According to the configuration, in addition to the effect of reducing the rise in the temperature of the light emitting elements 411 and the like, it is possible to reduce a possibility that electromagnetic noise emitted from the light emitting elements 411 propagates to the detectors 311. A configuration for heat dissipation disposed on the backs of the light emitting elements 411 may be a metal fin or the like.

In addition, a base material of the aperture array 43, in other words, the base material of the VCSEL array 44, may be a metal plate made of aluminum, or the like. In that case, the apertures 412 may be configured as through-holes having a predetermined diameter. In a case where the base material itself on which the light emitting elements 411 are disposed is a metal plate, the heat dissipation can be further improved. The through-holes as the apertures 412 may be implemented by laser processing, blast processing, or the like.

An optical filter that removes light other than reflected light, such as the sunlight and illumination light, may be disposed upstream or downstream of the optical unit 5. The optical filter is an element that transmits the sensing light and attenuates other light.

As illustrated in FIG. 20, an integrated microlens array 8 may be disposed between the optical unit 5 and the irradiation array unit 41. The integrated microlens array 8 includes irradiation auxiliary lenses 81 that are lenses for the light emitting elements 411, and a light-receiving auxiliary lenses 82 that are auxiliary lenses for focusing light through the apertures 412. A shape of the irradiation auxiliary lens 81 is not necessarily a convex lens but may be a concave lens or the like. Shapes of the irradiation auxiliary lenses 81 and the light-receiving auxiliary lenses 82 may be different. According to the configuration in which the irradiation auxiliary lenses 81 are provided, irradiation beams are easily adjusted to desired directions/shapes. According to the configuration in which the light-receiving auxiliary lenses 82 are provided, light reception efficiency can be improved.

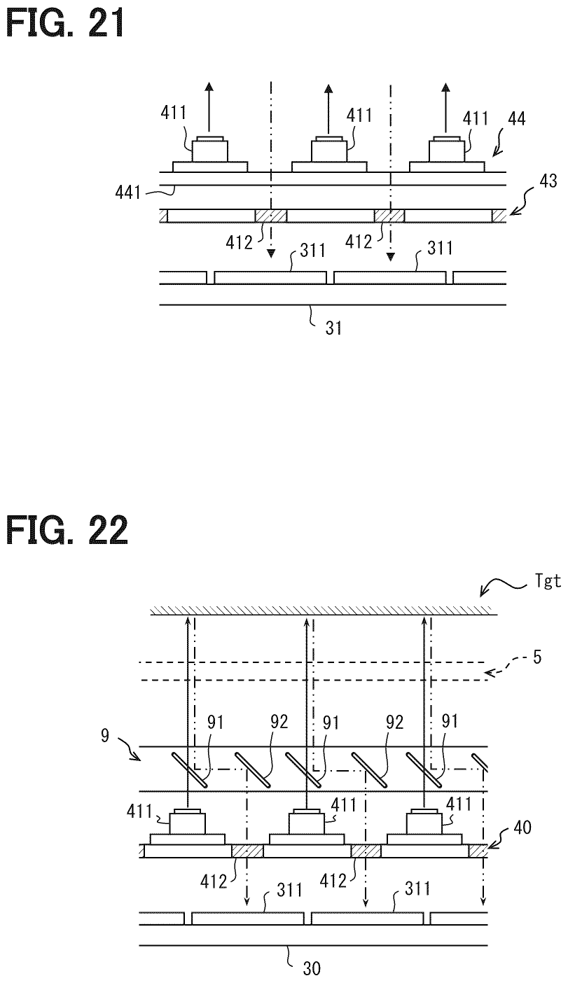

In the above description, the configuration in which the aperture array 43 and the VCSEL array 44 are integrated as the irradiation array unit 41 has been exemplified. However, the aperture array 43 and the VCSEL array 44 may be provided separately. As illustrated in FIG. 21, the aperture array 43 may be provided below the VCSEL array 44, independent of the VCSEL array 44. In that case, it is assumed that an array base material 441 on which the light emitting elements 411 are arranged on the VCSEL array 44 is implemented by using resin or the like that transmits the sensing light.

As illustrated in FIG. 22, an optical path distribution unit 9 may be disposed between the optical unit 5 and the irradiation substrate 40. The optical path distribution unit 9 includes an irradiation mirror 91 positioned above the light emitting elements 411, light receiving mirrors 92 positioned above the apertures 412, and a supporting body 93 that houses/fixes the irradiation mirrors 91 and the light receiving mirrors 92. There are a plurality of irradiation mirrors 91 and a plurality of light receiving mirrors 92.

The irradiation mirror 91 is configured to transmit the sensing light emitted from the light emitting element 411 as is, and may be a half mirror or a perforated mirror. The irradiation mirror 91 is fixed to the supporting body 93, at an angle in which the reflected light is reflected in a direction in which an adjacent light receiving mirror is present. The supporting body 93 is implemented by using a material that transmits the sensing light. The optical path distribution unit 9 is a solid having a plate shape as a whole. The light receiving mirrors 92 are mirrors that reflect the reflected light reflected by the irradiation mirrors toward directions in which the apertures 412 are present. The optical path distribution unit 9 corresponds to a mechanism in which emission and reception of the sensing light are coaxial at an upstream (outside) of the optical path distribution unit 9.

According to the configuration, the reflected light corresponding to the irradiation light from one light emitting element 411 enters one detector 311. That is, it is possible to make the light emitting element 411 and the detector 311 correspond to each other on a one-to-one basis. According to the configuration, effects such as improvement of the SNR and extension of a detection distance can be expected as compared with the above-described embodiment.

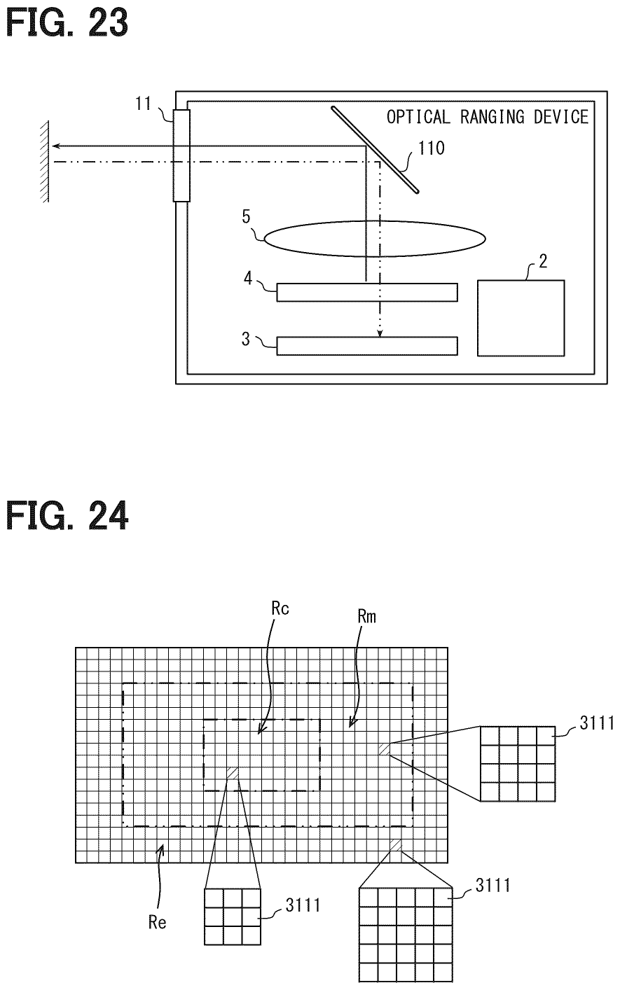

As illustrated in FIG. 23, a mirror 110 that bends a path of the sensing light may be disposed between the optical unit 5 and the window portion 11. The light receiving unit 3 is only required to optically overlap the irradiation unit 4. One or a plurality of mirrors may be interposed between the light receiving unit 3 and the irradiation unit 4. The mirror 110 may be a plane mirror or a concave mirror. The mirror 110 may be configured to be pivotable with a motor or the like. The optical ranging device 100 may be configured to be able to sweep and emit the sensing light by pivoting the mirror 110. The optical ranging device 100 may be capable of dynamically changing a detection direction by causing the mirror 110 to pivot.

In addition, the plurality of light emitting elements 411 is not necessarily arranged to form a plurality of rows. The irradiation unit 4 may include one row of light emitting elements 411. The number and arrangement of the light emitting elements 411 arranged on the irradiation substrate 40 can be appropriately changed.

Sizes of pixel groups may be different depending on positions thereof in the range image. The sizes of the pixel groups may be different between whether the pixel groups are in a central portion Rc or in a peripheral portion Re. As illustrated in FIG. 24, the number of light receiving elements 3111 included in a pixel positioned in the central portion Rc of the range image may be 9 (3×3), and the number of light receiving elements 3111 included in a pixel positioned in the peripheral portion Re may be 25 (5×5). The number of light receiving elements 3111 included in a pixel positioned in an intermediate portion Rm positioned between the central portion Rc and the peripheral portion Re may be 16 (4×4). The farther from a center of the range image, the less easily the reflected light reaches. Meanwhile, if the size of a pixel group is increased, sensitivity of detecting the reflected light can be increased. According to the above configuration, it is possible to reduce chances of a decrease in distance measurement sensitivity depending on positions in the range image.

In FIG. 24, an inside of a dash-dotted line is the central portion Rc, and an outside of the dash-dot-dot line is the peripheral portion Re. A portion surrounded by the dash-dotted line and the dash-dot-dot line corresponds to the intermediate portion Rm. FIG. 24 exemplifies an aspect in which the range image is divided into three parts of the central portion Rc, the intermediate portion Rm, and the peripheral portion Re. However, a section setting of the range image can be appropriately changed. The range image may be divided into two sections of the central portion Rc and peripheral portion Re, or may be divided into four or more sections. The size of the pixel group for each pixel may be set to increase in proportion to a distance from the center of the range image. As described above, the setting of the pixel groups is logical, and the pixel groups may be set to overlap each other.

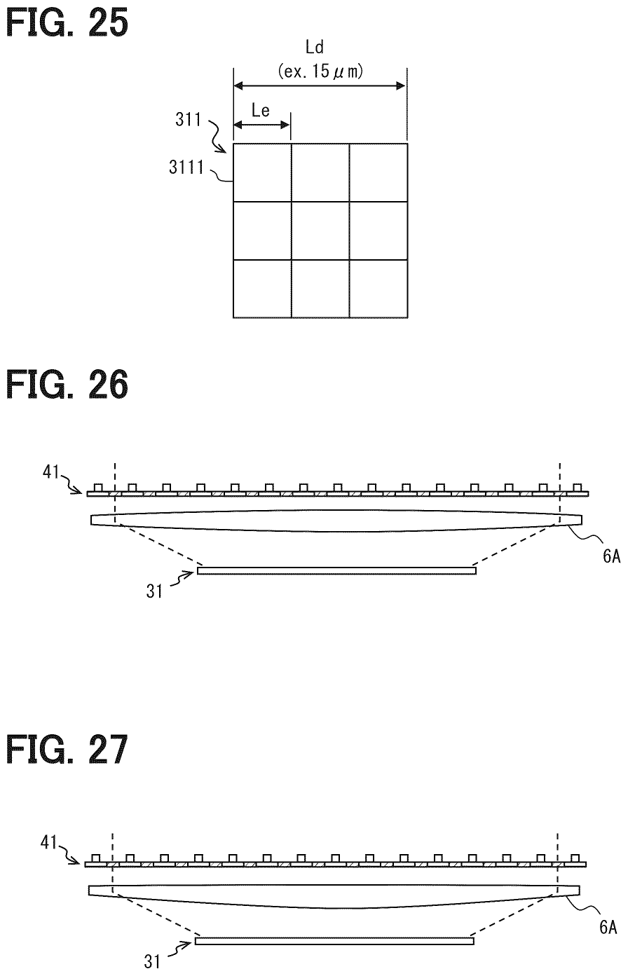

A size of the detector 311 is not limited to 30 μm. One side of the detector 311 may be 20 μm or 15 μm long, along with downsizing of the light receiving elements 3111 and development of dense mounting technology. The size of the detector 311 may be smaller than the arrangement interval of the apertures 412. As illustrated in FIG. 25, the detector 311 may have a square shape of 15 μm on a side, in which the light receiving elements 3111 are arranged in a 3×3 matrix. The number of light receiving elements 3111 included in one detector 311 may be changed to 25 (=5×5) or 36 (=6×6), while maintaining the size of the detector 311.

With development of highly-dense mounting technology of the light receiving elements 3111, vertical and horizontal lengths of the light-receiving array unit 31 may be set to 50% to 60% of the irradiation array unit 41, respectively. That is, an area of the light-receiving array unit 31 may be 25% to 36% of an area of the irradiation array unit 41.

In a configuration in which the light-receiving array unit 31 is smaller than the irradiation array unit 41, as illustrated in FIG. 26, a condenser lens 6A may be disposed between the light-receiving array unit 31 and the irradiation array unit 41. The condenser lens 6A is a lens for focusing light from each aperture 412 provided in the irradiation array unit 41, on the light-receiving array unit 31. The condenser lens 6A is only required to have an optical characteristic (for example, focal length) for forming an image on a surface of the light-receiving array unit 31. The condenser lens 6A may be a biconvex lens as illustrated in FIG. 26 or a plano-convex lens as illustrated in FIG. 27. The condenser lens 6A may be a convex meniscus lens or a Fresnel lens. The plano-convex lens refers to a lens in which one surface is flat and the other surface is formed in a convex shape. The convex meniscus lens refers to a lens in which one surface is convex and another surface is concave, and the center of the lens is formed to be thicker than a peripheral portion thereof. The Fresnel lens refers to a lens having a sawtooth cross section, obtained by concentrically dividing a lens as exemplified in FIG. 26 or FIG. 27 to reduce thickness thereof.

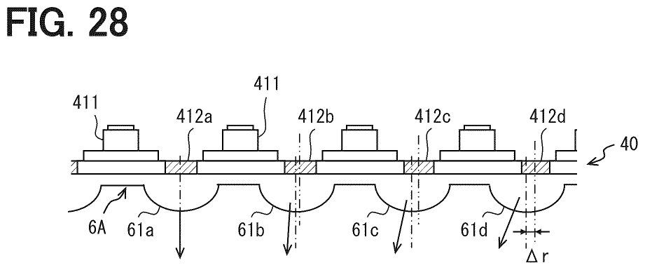

Directions of the light emitted from the aperture lenses 61 toward the light-receiving array unit 31 can also be adjusted by positions of the aperture lenses 61 with respect to the apertures 412. Thus, the condenser lens 6A may be a light-receiving microlens array 6X in which a position of each aperture lens 61 is finely adjusted. As illustrated in FIG. 28, the condenser lens 6A may be a light-receiving microlens array 6X in which the farther the aperture lenses 61 are from the center of the irradiation array unit 41, the more the lenses 61 are shifted from the respective apertures 412 positioned above, toward the center of the irradiation array unit 41.

An aperture 412a illustrated in FIG. 28 represents the aperture 412 positioned at the center of the irradiation array unit 41. The apertures 412b, 412c, and 412d sequentially represent the apertures 412 positioned far from the center of the irradiation array unit 41. The aperture lenses 61a to 61d are aperture lenses corresponding to the apertures 412a to 412d, respectively. The dash-dotted lines in FIG. 28 indicate optical axes of the aperture lenses 61. The dash-dot-dot lines in FIG. 28 indicate optical axes of the apertures 412. The optical axis of the aperture 412 refers to a line that passes through the center of the aperture 412 and is orthogonal to the substrate.

The farther the aperture lens 61 is from the center of the irradiation array unit 41 (in other words, the light-receiving microlens array 6X), the smaller offset amount Ar is set for the aperture lens 61. The offset amount Ar for a certain aperture lens 61 means a degree of deviation between the optical axis of the aperture 412 positioned above the aperture lens 61 and the optical axis of the aperture lens 61. The offset amount Ar of the aperture lens 61d may be set to be larger than the offset amount Ar of the aperture lens 61b. The offset amount Ar of the aperture lens 61a may be set to 0.

An offset direction is a direction in which the aperture lens 61 is shifted with respect to the aperture 412. The offset direction is set to a direction from the aperture 412 toward the center of the irradiation array unit 41. The positions of the individual aperture lenses 61 included in the light-receiving microlens array 6X as the condenser lens 6A are designed according to distances and directions of the respective corresponding apertures 412 from the center of the irradiation array unit 41. Therefore, at least either the offset amount Ar or the offset direction may be different for each aperture lens 61.

According to the configuration in which the condenser lens 6A is disposed between the irradiation array unit 41 and the light-receiving array unit 31, the light-receiving array unit 31 can be smaller than the irradiation array unit 41. From another viewpoint, according to the configuration in which the condenser lens 6A is disposed between the irradiation array unit 41 and the light-receiving array unit 31, an irradiation array unit 41 larger than the light-receiving array unit 31 can be disposed. If it is possible to upsize the irradiation array unit 41, this means that it is possible to upsize the individual light emitting elements 411. The larger in size of the light emitting element 411, the larger amount of light to be emitted, increasing the detection distance. That is, according to the configuration in which the condenser lens 6A is disposed between the irradiation array unit 41 and the light-receiving array unit 31, an object detection distance may be extended by increasing the size of the light emitting elements 411.

The optical ranging device 100 described above can be applied to various vehicles traveling on a road. A vehicle to which the system, device, method, or the like of the present disclosure is applied may be an owner car owned by an individual, or may be a service car. The service car is a vehicle provided for a car sharing service or a vehicle rental service. The service car includes a taxi, a fixed route bus, a transit bus, and the like. The service car may be a robot taxi, an unmanned operation bus, or the like on which the driver is not on board. The service car can broadly include vehicles that provide transport services. The service car can include a vehicle as an unmanned delivery robot that automatically transports load to a predetermined destination.

A glass plate may be disposed upward of the light emitting elements (111) so as to abut on upper ends of the light emitting elements.

The detectors (311) may be arranged in matrix, and the openings may face the detectors arranged in matrix.

The heat conductor (71, 71a, 72) may be arranged on a top or lateral side of the light emitting elements.

The device, system, and method thereof described in the present disclosure may be implemented by a dedicated computer that constitutes a processor programmed to execute one or a plurality of functions embodied by a computer program. The device and method thereof described in the present disclosure may be implemented by using a dedicated hardware logic circuit. The device and method thereof described in the present disclosure may be implemented by one or more dedicated computers including a combination of a processor configured to execute a computer program and one or more hardware logic circuits. As the processor, a CPU, an MPU, a graphics processing unit (GPU), a data flow processor (DFP), or the like can be adopted. Some or all of the functions of the control unit 2 may be implemented by using any of a system-on-chip (SoC), an integrated circuit (IC), and an FPGA. A concept of the IC also includes the ASIC.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An optical ranging device configured to detect a distance to a target by using a round-trip time of light, the optical ranging device comprising:
a light receiving module that is a plate-shaped member on which detectors are arranged, the detectors being configured to respond to sensing light having a predetermined wavelength;
light emitting elements which are vertical-cavity surface-emitting lasers and configured to emit the sensing light;
an aperture module disposed upward of the light receiving module, the aperture module being a plate-shaped member having point-shaped openings through which reflected light passes toward the detectors, the reflected light being the sensing light reflected by the target; and
a glass plate in contact with upper ends of the light emitting elements, wherein
the light emitting elements are provided on portions of the aperture module where the openings are not provided on the aperture module.

2. The optical ranging device according to claim 1, further comprising an optical unit configured to
focus the reflected light through each of the openings, and
allow the sensing light from the light emitting elements to enter the optical unit.

3. The optical ranging device according to claim 1, wherein
the light emitting elements are arranged on the aperture module such that one of the openings is arranged between two of the light emitting elements.

4. The optical ranging device according to claim 3, wherein
the one of the openings is arranged at equal distance from adjacent two of the light emitting elements.

5. The optical ranging device according to claim 1, wherein
at least one of the light emitting elements is disposed within 60 μm from one of the openings.

6. The optical ranging device according to claim 1, wherein
the openings are arranged in a matrix, and
the detectors face at least one of the openings.

7. The optical ranging device according to claim 6, wherein
one of the light emitting elements is disposed between adjacent two of the openings.

8. The optical ranging device according to claim 1, wherein
the openings are arranged in a staggered manner.

9. The optical ranging device according to claim 1, further comprising
a heat conductor arranged on a top or lateral side of the light emitting elements or a portion of the aperture module behind the light emitting elements.

10. The optical ranging device according to claim 1, wherein
outlines of the opening have a circular shape.

11. The optical ranging device according to claim 1, wherein
the aperture module is larger in size than the light receiving module, and
the optical ranging device further comprises a lens module disposed between the aperture module and the light receiving module and configured to focus light from the openings of the aperture module on the light receiving module.

12. An optical ranging device configured to detect a distance to a target by using a round-trip time of light, the optical ranging device comprising:
a light receiving module that is a plate-shaped member on which detectors are arranged, the detectors being configured to respond to sensing light having a predetermined wavelength;
light emitting elements which are vertical-cavity surface-emitting lasers and configured to emit the sensing light;
an aperture module disposed upward of the light receiving module, the aperture module being a plate-shaped member having openings through which reflected light passes toward the detectors, the reflected light being the sensing light reflected by the target; and
a glass plate in contact with upper ends of the light emitting elements, wherein
the light emitting elements are provided on portions of the aperture module where the openings are not provided on the aperture module.

13. The optical ranging device according to claim 12, further comprising
a heat conductor arranged on a portion of the aperture module behind the light emitting elements.

14. The optical ranging device according to claim 12, wherein
the opening are circular.

15. The optical ranging device according to claim 12, wherein
the openings are arranged in a staggered manner.

16. The optical ranging device according to claim 12, wherein
the aperture module is a module in which the openings are through-holes formed on a metal plate.

17. The optical ranging device according to claim 12, further comprising
an image generation part configured to generate a range image based on output signals from the detectors, each pixel of the range image indicating a distance to the target in a predetermined direction, wherein
each of the detectors includes light receiving elements, and
number of the light receiving elements included in each of the detectors is different between a central portion and a peripheral portion of the light receiving module.

18. An optical ranging device configured to detect a distance to a target by using a round-trip time of light, the optical ranging device comprising:
an irradiation module including a plate-shaped member and light emitting elements provided on the plate-shaped member, the light emitting elements being vertical-cavity surface-emitting lasers and configured to emit sensing light having a predetermined wavelength, the plate-shaped member transmitting the sensing light;
a light receiving module that is a plate-shaped member on which detectors are arranged, the detectors being configured to respond to the sensing light;
an aperture array that is a plate-shaped member including openings through which reflected light passes toward the detectors, the reflected light being the sensing light reflected by the target; and
a glass plate in contact with upper ends of the light emitting elements, wherein
the irradiation module is disposed upward of the light receiving module and faces the light receiving module, and
the aperture array is disposed between the light receiving module and the irradiation module.
